(19) United States
(12) Patent Application Publication
(10) Pub. No.: US 2023/0343507 A1
(43) Pub. Date: Oct. 26, 2023

(54) COIL COMPONENT

(71) Applicant: SAMSUNG ELECTRO-MECHANICS CO., LTD., Suwon-si (KR)

(72) Inventors: Jae Hun Kim, Suwon-si (KR); In Young Kang, Suwon-si (KR)

(73) Assignee: SAMSUNG ELECTRO-MECHANICS CO., LTD., Suwon-si (KR)

(21) Appl. No.: 18/100,094

(22) Filed: Jan. 23, 2023

(30) Foreign Application Priority Data
Apr. 25, 2022 (KR) 10-2022-0050679

(51) Int. Cl. H01F 27/29; H01F 27/32

(52) U.S. Cl. CPC H01F 27/292; H01F 27/324

(57) ABSTRACT

A coil component includes a body, a supporting member disposed within the body, a coil portion including a coil pattern disposed on at least one surface of the supporting member, a via pad connected to the coil pattern, and a via connected to the via pad, and an external electrode disposed on the body and connected to the coil portion. The via includes a plurality of side surfaces, one or more of the side surfaces is covered by the supporting member, and at least a portion of two or more of the side surfaces is non-covered by the supporting member.

### CROSS-REFERENCE TO RELATED APPLICATION(S)

This application claims benefit of priority to Korean Patent Application No. 10-2022-0050679 filed on Apr. 25, 2022 in the Korean Intellectual Property Office, the disclosure of which is incorporated herein by reference in its entirety.

### TECHNICAL FIELD

The present disclosure relates to a coil component.

### BACKGROUND

An inductor, a coil component, is a passive electronic component used in electronic devices along with a resistor and a capacitor.

As electronic devices have been designed to have high-performance and a reduced size, the number of electronic components used in electronic devices has been increased and sizes thereof have been reduced.

In the case of a miniaturized thin film power inductor, a via for electrical connection between coil layers may be included, and a via pad having a larger line width than an end of an innermost turn of the coil pattern may be formed to ensure alignment between the via and the coil. However, the core area may not be sufficiently secured due to a via pad area.

### SUMMARY

An aspect of the present disclosure is to provide a coil component which may, by reducing an area occupied by a via pad in the coil component and securing the area of a core region, have a reduced size and high capacitance.

An aspect of the present disclosure is to provide a coil component in which, even when alignment between a via and a via pad is slightly misaligned or sizes of the via and the via pad is different, connection reliability between a coil pattern and the via may be maintained.

According to an aspect of the present disclosure, a coil component includes a body, a supporting member disposed within the body, a coil portion including a coil pattern disposed on at least one surface of the supporting member, a via pad connected to the coil pattern, and a via connected to the via pad, and an external electrode disposed on the body and connected to the coil portion. The via includes a plurality of side surfaces, one or more of the side surfaces is covered by the supporting member, and at least a portion of two or more of the side surfaces is non-covered by the supporting member.

According to another aspect of the present disclosure, a coil component includes a body, a supporting member disposed within the body, a coil portion including a coil pattern disposed on at least one surface of the supporting member, a via pad connected to the coil pattern, and a via connected to the via pad, and an external electrode disposed on the body and connected to the coil portion. Among the via pad and the supporting member, only the supporting member includes a via hole in which the via is disposed, and the via includes at least one side surface non-covered by the supporting member.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective diagram illustrating a coil component and an enlarged diagram illustrating a portion of the coil component according to a first embodiment of the present disclosure;

FIG. 2 is a diagram illustrating a connection relationship between the elements of the coil component in the enlarged diagram in FIG. 1;

FIG. 3 is a plan diagram illustrating the coil component in the enlarged diagram in FIG. 1;

FIG. 4 is a cross-sectional diagram taken along I-I′ in FIG. 1;

FIG. 5 is a cross-sectional diagram taken along II-II′ in FIG. 1;

FIG. 6 is a diagram illustrating a via and a via pad of a coil component according to a second embodiment of the present disclosure, corresponding to FIG. 3;

FIG. 7 is a diagram illustrating a via and a via pad of a coil component according to a third embodiment of the present disclosure, corresponding to FIG. 3; and

FIGS. 8A and 8B are diagrams illustrating a process of forming a coil portion using a barrier rib method in order.

### DETAILED DESCRIPTION

The terms used in the example embodiments are used to simply describe an example embodiment, and are not intended to limit the present disclosure. A singular term includes a plural form unless otherwise indicated. The terms, “include,” “comprise,” “is configured to,” and the like, of the description are used to indicate the presence of features, numbers, steps, operations, elements, portions or combination thereof, and do not exclude the possibilities of combination or addition of one or more features, numbers, steps, operations, elements, portions or combination thereof. Also, the term “disposed on,” “disposed on,” and the like, may indicate that an element is disposed on or beneath an object, and does not necessarily mean that the element is disposed on the object with reference to a gravity direction.

The term “coupled to,” “combined to,” and the like, may not only indicate that elements are directly and physically in contact with each other, but also include the configuration in which the other element is interposed between the elements such that the elements are also in contact with the other component.

In the drawings, an L direction is a first direction or a length direction, a W direction is a second direction or a width direction, a T direction is a third direction or a thickness direction.

Sizes and thicknesses of elements illustrated in the lead-out portions are indicated as examples for ease of description, and example embodiments in the present disclosure an example embodiment thereof is not limited thereto.

In electronic devices, various types of electronic components may be used, and various types of coil components may be used between the electronic components to remove noise, or for other purposes.

In other words, in electronic devices, a power inductor, a high frequency inductor (HF inductor), a general bead, a high frequency bead (GHz bead), a common mode filter, and the like may be used between the electronic components to remove noise, or for other purposes.

### First Embodiment

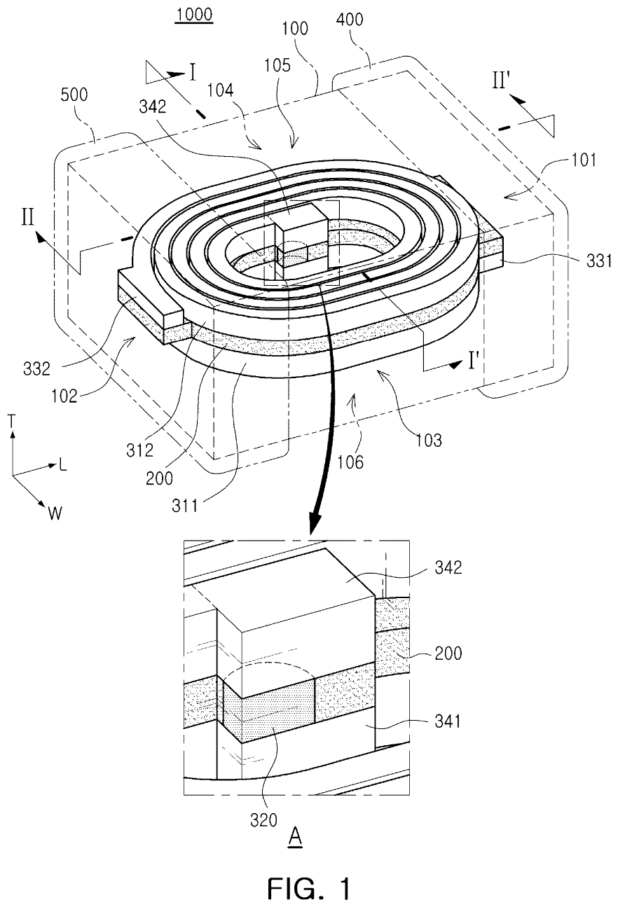

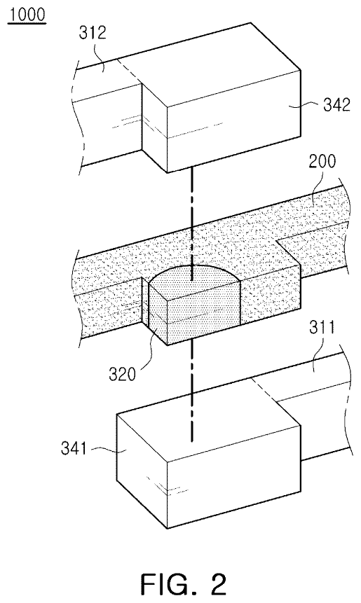

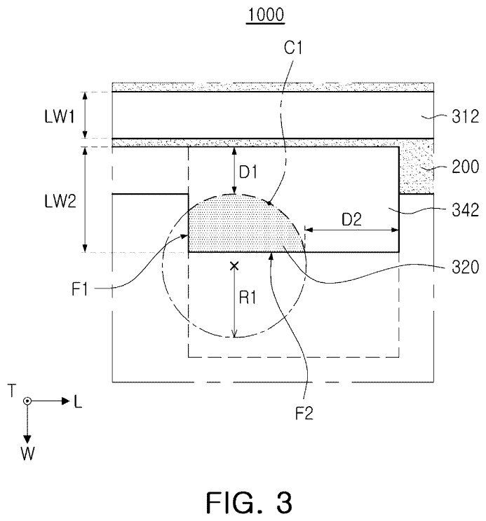

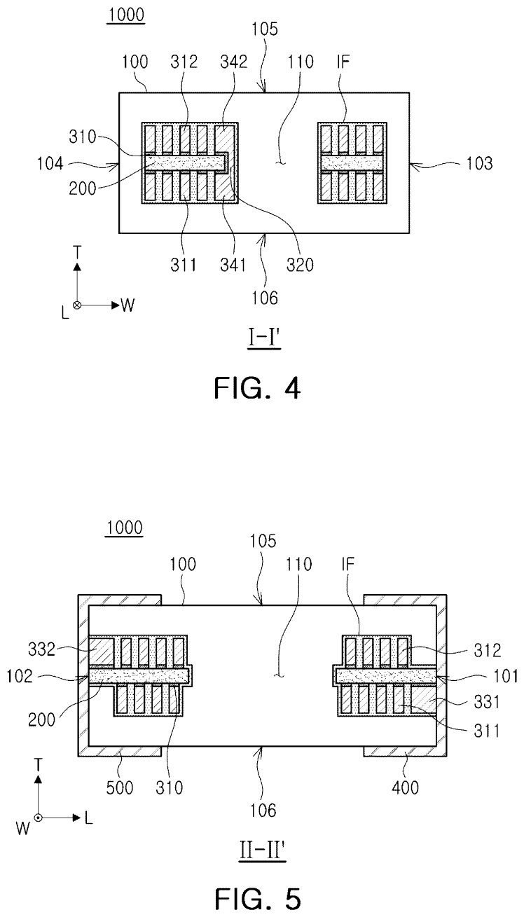

FIG. 1 is a perspective diagram illustrating a coil component and an enlarged diagram illustrating a portion of the coil component according to a first embodiment. FIG. 2 is a diagram illustrating a connection relationship between the elements of the coil component in the enlarged diagram in FIG. 1. FIG. 3 is a plan diagram illustrating the coil component in the enlarged diagram in FIG. 1. FIG. 4 is a cross-sectional diagram taken along I-I′ in FIG. 1. FIG. 5 is a cross-sectional diagram taken along II-II′ in FIG. 1.

To more clearly illustrate the coupling between the components, an external insulating layer on the body 100 applied to this embodiment is not illustrated.

Referring to FIGS. 1 to 5, the coil component 1000 in the first embodiment may include a body 100, a supporting member 200, a coil portion 300, first and second external electrodes 400 and 500, and may further include an insulating layer IF.

The body 100 may form an exterior of the coil component 1000 in the embodiment, and the coil portion 300 and the supporting member 200 may be disposed in the body 100.

The body 100 may have a hexahedral shape.

The body 100 may include a first surface 101 and a second surface 102 opposing each other in the length direction L, a third surface 103 and a fourth surface 104 opposing each other in the width direction W, and a fifth surface 105 and a sixth surface 106 opposing each other in the thickness direction T, with respect to the directions in FIG. 1. Each of the first to fourth surfaces 101, 102, 103 and 104 of the body 100 may be a wall surface of the body 100 connecting the fifth surface 105 to the sixth surface 106 of the body 100. Hereinafter, both end surfaces (one end surface and the other end surface) of the body 100 may refer to the first surface 101 and the second surface 102 of the body 100, both side surfaces (one side surface and the other side surface) of the body 100 may refer to the third surface 103 and the fourth surface 104 of the body 100, and one surface and the other surface of the body 100 may refer to the sixth surface 106 and the fifth surface 105 of the body 100.

The body 100 may be formed such that the coil component in which the external electrodes 400 and 500 are formed may have a length of 2.5 mm, a width of 2.0 mm and a thickness of 1.0 mm, may have a length of 2.0 mm, a width of 1.2 mm and a thickness of 0.65 mm, may a length of 1.6 mm, a width of 0.8 mm and a thickness of 0.8 mm, may have a length of 1.0 mm, a width of 0.5 mm and a thickness of 0.5 mm, or may have a length of 0.8 mm, a width of 0.4 mm and a thickness of 0.65 mm, but an example embodiment thereof is not limited thereto. Since the above-described numerical value examples for the length, width, and thickness of the coil component 1000 do not reflect process errors, and a numerical value in a range recognized as a process error may correspond to the above-described numerical value examples.

The length of the above-described coil component 1000 may be a maximum value among dimensions of a plurality of line segments connecting two outermost boundary lines of the coil component 1000, opposing each other in the length direction L, to each other in parallel to the length direction L, on an optical microscope image or a scanning electron microscope (SEM) image with respect to a cross-section in the length direction L-thickness direction T taken from the central portion of the coil component 1000 taken in the width direction W. Alternatively, the length of the coil component 1000 may refer to a minimum value among the dimensions of the plurality of line segments described above. Alternatively, the length of the coil component 1000 may refer to an arithmetic mean value of at least three or more of the dimensions of the plurality of line segments described above. Here, the plurality of line segments parallel to the length direction L may be spaced apart from each other by an equal distance in the thickness direction T, but an example embodiment thereof is not limited thereto.

The thickness of the above-described coil component 1000 be a maximum value among dimensions of a plurality of line segments connecting two outermost boundary lines of the coil component 1000, opposing each other in the thickness direction T, to each other in parallel to the thickness direction T, on an optical microscope image or a scanning electron microscope (SEM) image with respect to a cross-section in the length direction L-thickness direction T taken from the central portion of the coil component 1000 taken in the width direction W. Alternatively, the length of the coil component 1000 may refer to a minimum value among the dimensions of the plurality of line segments described above. Alternatively, the length of the coil component 1000 may refer to an arithmetic mean value of at least three or more of the dimensions of the plurality of line segments described above. Here, the plurality of line segments parallel to the thickness direction T may be spaced apart from each other by an equal distance in the thickness direction T, but an example embodiment thereof is not limited thereto.

The width of the above-described coil component 1000 may be a maximum value among dimensions of a plurality of line segments connecting two outermost boundary lines of the coil component 1000, opposing each other in the width direction W, to each other and in parallel to the width direction W, on an optical microscope image or a scanning electron microscope (SEM) image with respect to a cross-section in the length direction L-width direction W taken from the central portion of the coil component 1000 taken in the thickness direction T. Alternatively, the width of the coil component 1000 may refer to a minimum value among the dimensions of the plurality of line segments connecting two outermost boundary lines of the coil component 1000, opposing each other in the width direction W, to each other and in parallel to the width direction W. Alternatively, the width of the coil component 1000 may refer to an arithmetic mean value of at least three or more of the dimensions of the plurality of line segments connecting two outermost boundary lines of the coil component 1000, opposing each other in the width direction W, to each other and in parallel to the width direction W. Here, the plurality of line segments parallel to the width direction W may be spaced apart from each other by an equal distance in the thickness direction T, but an example embodiment thereof is not limited thereto.

Alternatively, each of the length, width and thickness of the coil component 1000 may be measured by a micrometer measurement method. The micrometer measurement method may be of determining a zero point with a gage repeatability and reproducibility (R&R) micrometer, inserting the coil component 1000 in the embodiment between tips of the micrometer, and measuring by turning a measuring lever of a micrometer. In measuring the length of the coil component 1000 by the micrometer measurement method, the length of the coil component 1000 may refer to a value measured once or may refer to an arithmetic average of values measured a plurality of times, which may be equally applied to the width and thickness of the coil component 1000.

The body 100 may include an insulating resin and a magnetic material. Specifically, the body 100 may be formed by laminating one or more magnetic composite sheets in which a magnetic material is dispersed in an insulating resin. The magnetic material may be ferrite or a magnetic metal powder.

A ferrite powder may be at least one of, for example, spinel-type ferrite such as Mg—Zn-based ferrite, Mn—Zn-based ferrite, Mn—Mg-based ferrite, Cu—Zn-based ferrite, Mg—Mn—Sr-based ferrite, Ni—Zn-based ferrite, hexagonal ferrites such as Ba—Zn-based ferrite, Ba—Mg-based ferrite, Ba—Ni-based ferrite, Ba—Co-based ferrite, Ba—Ni—Co-based ferrite, garnet-type ferrites such as Y-based ferrite, and Li-based ferrites.

Metal magnetic powder may include one or more selected from a group consisting of iron (Fe), silicon (Si), chromium (Cr), cobalt (Co), molybdenum (Mo), aluminum (Al), niobium (Nb), copper (Cu) and nickel (Ni). For example, the magnetic metal powder may be at least one of pure iron powder, Fe—Si alloy powder, Fe—Si—Al alloy powder, Fe—Ni alloy powder, Fe—Ni—Mo alloy powder, Fe—Ni—Mo—Cu alloy powder, Fe—Co alloy powder, Fe—Ni—Co alloy powder, Fe—Cr alloy powder, Fe—Cr—Si alloy powder, Fe—Si—Cu—Nb alloy powder, Fe—Ni—Cr-based alloy powder and Fe—Cr—Al alloy powder.

The metal magnetic powder may be amorphous or crystalline. For example, the magnetic metal powder may be a Fe—Si—B—Cr amorphous alloy powder, but an example embodiment thereof is not limited thereto.

Each particle of ferrite and magnetic metal powder may have an average diameter of about 0.1 μm to 30 μm, but an example embodiment thereof is not limited thereto.

The body 100 may include two or more types of magnetic materials dispersed in a resin. Here, the different types of magnetic materials may indicate that the magnetic materials dispersed in the resin may be distinguished from each other by any one of an average diameter, composition, crystallinity, and shape.

In the description below, the magnetic material may be a magnetic metal powder, but an example embodiment thereof is not limited to the body 100 having a structure in which magnetic metal powder is dispersed in an insulating resin.

The insulating resin may include epoxy, polyimide, a liquid crystal polymer, etc. alone or in combination but an example embodiment thereof is not limited thereto.

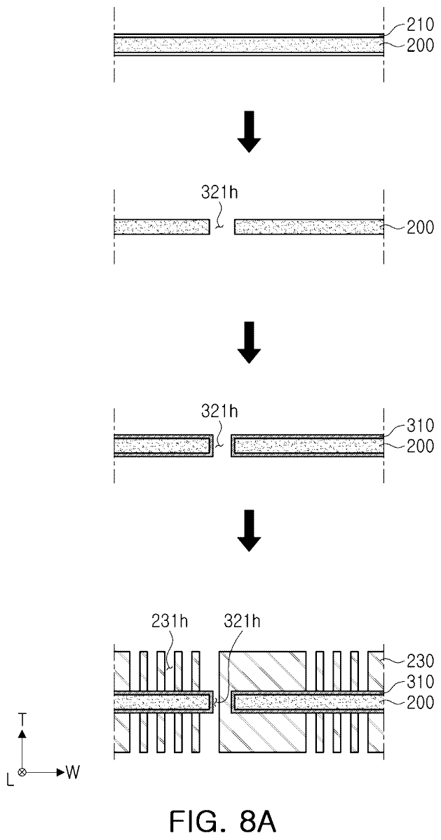

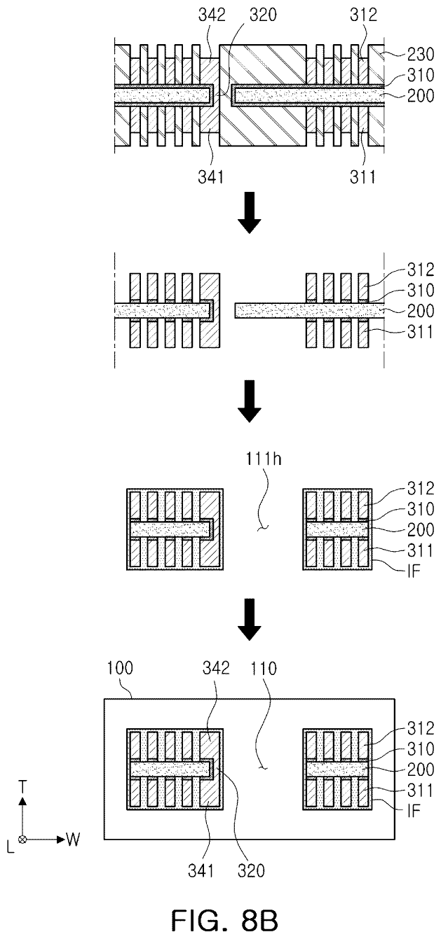

Referring to FIGS. 1, 4 to 5, the body 100 includes a core 110 penetrating the supporting member 200 and the coil portion 300. The core 110 may be formed by filling a through-hole 111h (labeled in FIG. 8B) penetrating a center of the coil portion 300 and a center of the supporting member 200 with a magnetic composite sheet including a magnetic material, but an example embodiment thereof is not limited thereto.

The supporting member 200 may be disposed in the body 100. The supporting member 200 may support the coil portion 300. Also, the supporting member 200 may support a barrier rib 230 used during the process of forming the coil portion 300, and the central portion of the supporting member 200 may be removed during the forming process for trimming the core 110, and the through-hole 111h may be formed. The supporting member 200 may be trimmed along the shapes of the via pads 341 and 342 and may have a shape corresponding to the via pads 341 and 342.

Referring to FIGS. 1 to 4, a via hole 321h (labeled in FIG. 8A) may be partially removed from the side surface of the supporting member 200 formed toward the core 110 such that an inwardly curved surface may be formed. This portion of the supporting member 200 may be in contact with the first non-exposed side surface C1 of the via 320 and may have an inwardly curved arc shape, but an example embodiment thereof is not limited thereto.

The supporting member 200 may be formed of an insulating material including a thermosetting insulating resin such as an epoxy resin, a thermoplastic insulating resin such as polyimide or an insulation material including photosensitive insulating resin, or an insulating material impregnated with a reinforcing material such as glass fiber or inorganic filler in the above-mentioned insulating resin. For example, the supporting member 200 may be formed of an insulating material such as prepreg, Ajinomoto build-up film (ABF), FR-4, bismaleimide triazine (BT) resin, and photo imaginable dielectric (PID) but an example embodiment thereof is not limited thereto.

As inorganic fillers, at least one material selected from the group consisting of silica (silicon dioxide, SiO₂), alumina (aluminum oxide, Al₂O₃), silicon carbide (SiC), barium sulfate (BaSO₄), talc, mud, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃) and calcium zirconate (CaZrO₃) may be used.

When the supporting member 200 is formed of an insulating material including a reinforcing material, the supporting member 200 may provide superior rigidity. When the supporting member 200 is formed of an insulating material not including glass fibers, it may be advantageous to reduce the thickness of the coil component 1000 according to the embodiment. Also, based on the body 100 of the same size, the volume occupied by the coil portion 300 and/or the magnetic metal powder may be increased, thereby improving component properties. When the supporting member 200 is formed of an insulating material including a photosensitive insulating resin, the number of processes for forming the coil portion 300 may be reduced, such that production costs may be reduced, and fine vias 320 may be formed.

The thickness of the supporting member 200 may be, for example, 10 μm or more and 50 μm or less, but an example embodiment thereof is not limited thereto.

The coil portion 300 may be disposed in the body 100 and may exhibit properties of the coil component 1000. For example, when the coil component 1000 in the embodiment is used as a power inductor, the coil portion 300 may store an electric field as a magnetic field and may maintain an output voltage, thereby stabilizing power of the electronic device.

The coil component 1000 according to the embodiment may include the coil portion 300 supported by the supporting member 200 in the body 100.

Referring to FIGS. 1 and 4 to 5, the coil portion 300 may include first and second coil patterns 311 and 312, vias 320, and first and second via pads 341 and 342, and first and second lead-out portions 331 and 332. Specifically, with respect to the direction of FIG. 1, the first coil pattern 311, the first lead-out portion 331, and the first via pad 341 may be disposed on the lower surface of the supporting member 200 facing the sixth surface 106 of the body 100, and the second coil pattern 312, the second lead-out portion 332, and the second via pad 342 may be disposed on the upper surface of the supporting member 200 facing the fifth surface 105 of the body 100.

Referring to FIGS. 1 and 4 to 5, each of the first coil pattern 311 and the second coil pattern 312 may have a spiral plane forming at least one turn with the core 110 as an axis. The first coil pattern 311 may form at least one turn on the lower surface of the supporting member 200 with the core 110 as an axis. The second coil pattern 312 may form at least one turn on the upper surface of the supporting member 200 with the core 110 as an axis.

Referring to FIGS. 1 and 2, the coil portion 300 may include via pads 341 and 342 connected to the coil patterns 311 and 312, respectively. The via pads 341 and 342 may improve connection reliability between the via 320 and the coil patterns 311 and 312 in the miniaturized coil component 1000.

Specifically, the first via pad 341 may be formed on an end of an innermost turn of the first coil pattern 311 disposed on the lower surface of the supporting member 200, and the second via pad 342 may be formed on an end of the innermost turn of the second coil pattern 312 disposed on the upper surface of the supporting member 200.

Referring to the enlarged diagram (A) of FIG. 1, one side surface of the via pads 341 and 342 may be coplanar with the side surface exposed toward the core 110 among the side surfaces of the via 320. However, an example embodiment thereof is not limited thereto.

Referring to FIG. 2, the first and second via pads 341 and 342 may be connected to each other by a via 320, and the upper and lower surfaces of the via 320 may be covered by the via pads 341 and 342 with respect to the direction in FIG. 1.

Referring to FIG. 3, the line width LW2 of the via pads 341 and 342 may be formed to be larger than the line width LW1 of the coil patterns 311 and 312. Accordingly, the via pads 341 and 342 may extend from the coil patterns 311 and 312 and may protrude toward the core 110, but an example embodiment thereof is not limited thereto.

Here, the line width LW1 of the above-described coil patterns 311 and 312 may refer to an arithmetic mean value of at least three or more of the dimensions of the plurality of line segments connecting two outermost boundary lines of linear-shaped coil turn of the coil patterns 311 and 312, opposing each other in the width direction W, to each other and in parallel to the width direction W on an optical microscope image or a scanning electron microscope (SEM) image with respect to a cross-section in the length direction L-width direction W taken from the central portion of each of the coil patterns 311 and 312 taken in the thickness direction T. Here, the plurality of line segments parallel to the width direction W may be spaced apart from each other by an equal distance in the thickness direction T, but an example embodiment thereof is not limited thereto.

Meanwhile, the line width LW2 of the via pads 341 and 342 may also be measured in the same manner as described above.

Referring to FIGS. 1 to 3, the coil portion 300 may include a via 320 partially penetrating the supporting member 200 and electrically connecting the first and second coil patterns 311 and 312 on both surfaces of the supporting member 200 to each other.

The via 320 may electrically connect the first and second coil patterns disposed on both surfaces of the supporting member 200 to each other. Specifically, based on the direction of FIG. 1, the lower surface of the via 320 may be connected to the first via pad 341 extending from the first coil pattern 311, and the upper surface of the via 320 may be connected to the second via pad 342 extending from the second coil pattern 312.

The via 320 may be disposed in the center of the via pads 341 and 342 and may be formed in a circular shape, or may have a shape in which a portion of the circle is removed by being deviated from the center of the via pads 341 and 342. Here, the partially removed region may be semi-circular, arc-shaped, or a combination thereof based on the L-W cross-section, but an example embodiment thereof is not limited thereto.

Referring to FIG. 2, the via 320 in this embodiment may include a plurality of side surfaces, one or more of the plurality of side surfaces may be covered by the supporting member 200, and at least a portion of two or more of the plurality of side surfaces may not be covered by the supporting member 200 and may be exposed.

Here, among the plurality of side surfaces of the via 320, the side surface not covered by the supporting member 200 and exposed may include first and second exposed side surfaces F1 and F2, and the first and second exposed side surfaces F1 and F2 may be formed to meet while sharing one edge.

Also, the first and second exposed side surfaces F1 and F2 may be formed to meet vertically, but an example embodiment thereof is not limited thereto. In this case, “meeting vertically” may indicate that the first and second exposed side surfaces F1 and F2 may meet at an angle of 90 degrees or around 90 degrees based on the L-W cross-section, and may include a process error, and the example embodiment is not limited to meeting at exactly 90 degrees.

Referring to FIGS. 2 and 3, each of the first and second exposed side surfaces F1 and F2 of the via 320 may be planar. Also, each of the first and second exposed side surfaces F1 and F2 of the via 320 may be a cut-surface. Considering a manufacturing process, this shape may be formed by the barrier rib 230 or may be formed by being removed in a trimming process, but an example embodiment thereof is not limited thereto.

Also, when a side surface covered by the supporting member 200 among a plurality of side surfaces of the via 320 is referred to as a non-exposed side surface C1, the non-exposed side surface C1 may be formed as a curved surface. The non-exposed side surface C1 may have an arc shape, and may have a constant curvature for each portion, or may have a different curvature depending on positions. Also, the center of curvature of the non-exposed side surface C1 may be disposed in the via pads 341 and 342 regions or outside the via pad 341 and 342 regions based on the L-W cross-section. In other words, the position of the center of curvature of the non-exposed side surface C1 may be varied according to the size or alignment position of the via 320 and the via pads 341 and 342.

Referring to FIG. 3, in the embodiment, the center of curvature of the non-exposed side surface C1 may be disposed outside the via pads 341 and 342 regions, but an example embodiment thereof is not limited thereto.

Also, the distance D1 in the W direction and the distance D2 in the L direction between the non-exposed side surface C1 of the via 320 and the side surfaces of the via pads 341 and 342 on the L-W cross-section may be formed differently. However, an example embodiment thereof is not limited thereto.

Here, the center of curvature or radius of curvature R1 of the non-exposed side surface C1 or the distance between the non-exposed side surface C1 and the side surfaces of the via pads 341 and 342 may be measured in the same manner as in the measurements of the line width LW1 of the coil patterns 311 and 312 using an optical microscope or scanning electron microscope (SEM) image with respect to a cross-section in the longitudinal direction L-width direction W in the central portion of the coil patterns 311 and 312 in the thickness direction T.

Referring to FIGS. 1 and 5, the coil portion 300 may include first and second lead-out portions 331 and 332 exposed to (or extending from) the first and second surfaces 101 and 102 of the body 100, respectively.

The first lead-out portion 331 may be connected to the first coil pattern 311, may be exposed to the first surface 101 of the body 100, and may be connected to a first external electrode 400. Also, the second lead-out portion 332 may be connected to the second coil pattern 312, may be exposed to the second surface 102 of the body 100, and may be connected to a second external electrode 500.

That is, the input from the first external electrode 400 may pass through the first lead-out portion 331, the first coil pattern 311, the first via pad 341, the via 320, the second via pad 342, the second coil pattern 312, and the second lead-out portion 332 and may be output through the second external electrode 500.

Accordingly, the coil portion 300 may function as a single coil between the first and second external electrodes 400 and 500.

At least one of the first and second coil patterns 311 and 312, the first and second via pads 341 and 342, the via 320, and the first and second lead-out portions 331 and 332 may include at least one conductive layer.

For example, when the first coil pattern 311, the first via pad 341, the via 320, and the first lead-out portion 331 are formed on the lower surface of the supporting member 200 by plating, each of the first coil pattern 311, the first via pad 341, the via 320, and the first lead-out portion 331 may include a seed layer 310 and an electrolytic plating layer. Here, the electroplating layer may have a single-layer structure or a multilayer structure. The electroplating layer having a multilayer structure may be formed in a conformal film structure in which an electroplating layer is formed along the surface of the other electroplating layer, and an electroplating layer is laminated on one surface of the other electroplating layer. The seed layer 310 may be formed by an electroless plating method or a vapor deposition method such as sputtering. The seed layers 310 of the first coil pattern 311, the first via pad 341, the via 320, and the first lead-out portion 331 may be integrated such that a boundary may not be formed therebetween, but an example embodiment thereof is not limited thereto. The electrolytic plating layers of the first coil pattern 311, the first via pad 341, the via 320, and of the first lead-out portion 331 may be integrated such that a boundary may not be formed therebetween, but an example embodiment thereof is not limited thereto.

Each of the first coil pattern 311, the first via pad 341, the via 320, and the first lead-out portion 331 may be formed of a conductive material such as copper (Cu), aluminum (Al), silver (Ag), tin (Sn), gold (Au), nickel (Ni), lead (Pb), titanium (Ti), chromium (Cr), or alloys thereof, but an example embodiment thereof is not limited thereto.

Referring to FIGS. 4 and 5, the coil component 1000 according to the embodiment may further include an insulating layer IF. The insulating layer IF may integrally cover the coil portion 300 and the supporting member 200.

Specifically, the insulating layer IF may be disposed between the coil portion 300 and the body 100 and between the supporting member 200 and the body 100. The insulating layer IF may be formed along the surface of the supporting member 200 on which the first and second coil patterns 311 and 312, the first and second via pads 341 and 342, and the first and second lead-out portions 331 and 332 are formed, but an example embodiment thereof is not limited thereto.

Referring to FIGS. 3 to 4, when the coil component 1000 according to the embodiment further includes the insulating layer IF, the first and second exposed side surfaces F1 and F2 of the via 320 may be in contact with the insulating layer IF.

The insulating layer IF may fill a region between turns of the first and second coil patterns 311 and 312 adjacent to each other and a region between the first and second lead-out portions 331 and 332 and the first and second coil patterns 311 and 312, respectively, and may insulate between the coil turns.

The insulating layer IF may be configured to insulate the coil portion 300 and the body 100, and may include a generally used insulating material such as parylene, but an example embodiment thereof is not limited thereto. As another example, the insulating layer IF may include an insulating material such as an epoxy resin other than parylene. The insulating layer IF may be formed by vapor deposition, but an example embodiment thereof is not limited thereto. As another example, the insulating film IF may be formed by laminating and curing an insulating film for forming the insulating film IF on both surfaces of the supporting member 200 on which the coil portion 300 is formed, or may be may be formed by coating and curing an insulating paste for forming the insulating film IF on both surfaces of the supporting member 200 on which the coil portion 300 is formed. Accordingly, the insulating film IF may not be provided in the embodiment. That is, in the case in which the body 100 has sufficient electrical resistance at the designed operating current and voltage of the coil component 1000 according to the embodiment, the insulating film IF may not be provided in the embodiment.

The external electrodes 400 and 500 may be disposed on the body 100 and may spaced apart from each other and may be connected to the coil portion 300, respectively. Specifically, the first external electrode 400 may be disposed on the first surface 101 of the body 100, and may be in contact with and connected to the first lead-out portion 331 exposed to the first surface 101 of the body 100, and the second external electrode 500 may be disposed on the second surface 102 of the body 100 and may be in contact with and connected to the second lead-out portion 332 exposed to the second surface 102 of the body 100.

The first external electrode 400 may be disposed on the first surface 101 of the body 100 and may extend to at least a portion of the third to sixth surfaces 103, 104, 105, and 106 of the body 100. The second external electrode 500 may be disposed on the second surface 102 of the body 100 and may extend to at least a portion of the third to sixth surfaces 103, 104, 105 and 106 of the body 100.

The first and second external electrodes 400 and 500 disposed on the first surface 101 and the second surface 102 of the body 100, respectively, may extend only to the sixth surface 106 of the body 100.

In this case, the first external electrode 400 may include a first pad portion disposed on the sixth surface 106 of the body 100, and a first extension part disposed on the first surface 101 of the body 100 and connecting the first lead-out portion 331 to the first pad portion.

Also, the second external electrode 500 may include a second pad portion spaced apart from the first pad portion on the sixth surface 106 of the body 100, and a second extension portion disposed on the second surface 102 of the body 100 and connecting the second lead-out portion 332 to the second pad portion.

The pad part and the extension part may be formed together in the same process and may be integrated with each other such that a boundary may not be formed therebetween, but an example embodiment thereof is not limited thereto.

The external electrodes 400 and 500 may be formed by a vapor deposition method such as sputtering and/or a plating method, but an example embodiment thereof is not limited thereto.

The external electrodes 400 and 500 may be formed of a conductive material such as copper (Cu), aluminum (Al), silver (Ag), tin (Sn), gold (Au), nickel (Ni), lead (Pb), chromium (Cr), titanium (Ti), or alloys thereof, but an example embodiment thereof is not limited thereto.

The external electrodes 400 and 500 may be formed in a single-layer or multilayer structure. For example, the external electrodes 400 and 500 may include a first conductive layer including copper (Cu), a second conductive layer disposed on the first conductive layer and including nickel (Ni), and a third conductive layer disposed on the second conductive layer and including tin (Sn). At least one of the second conductive layer and the third conductive layer may be formed to cover the first conductive layer, but an example embodiment thereof is not limited thereto. The first conductive layer may be a plating layer or a conductive resin layer formed by coating and curing a conductive resin including a conductive powder including at least one of copper (Cu) and silver (Ag) and a resin. The second and third conductive layers may be plating layers, but an example embodiment thereof is not limited thereto.

The coil component 1000 according to the embodiment may further include an external insulating layer disposed on the third to sixth surfaces 103, 104, 105, and 106 of the body 100. The external insulating layer may be disposed in a region other than the region in which the external electrodes 400 and 500 are disposed.

At least a portion of the external insulating layers disposed on the third to sixth surfaces 103, 104, 105, and 106 of the body 100, respectively, may be formed in the same process and may be integrated with each other without forming a boundary therebetween, but an example embodiment thereof is not limited thereto.

The outer insulating layer may be formed by forming an insulating material for forming the outer insulating layer by a method such as a printing method, vapor deposition, spray application method, or film lamination method, but an example embodiment thereof is not limited thereto.

The outer insulating layer may include a thermoplastic resin such as polystyrene-based resin, vinyl acetate-based resin, polyester-based resin, polyethylene-based resin, polypropylene-based resin, polyamide-based resin, rubber-based resin, acrylic-based resin, a thermosetting resin such as phenol-based resin, epoxy-based resin, urethane-based resin, melamine-based resin, alkyd-based resin, a photosensitive resin, parylene, SiOₓ or SiNₓ. The outer insulating layer may further include an insulating filler such as an inorganic filler, but an example embodiment thereof is not limited thereto.

### Second and Third Embodiments

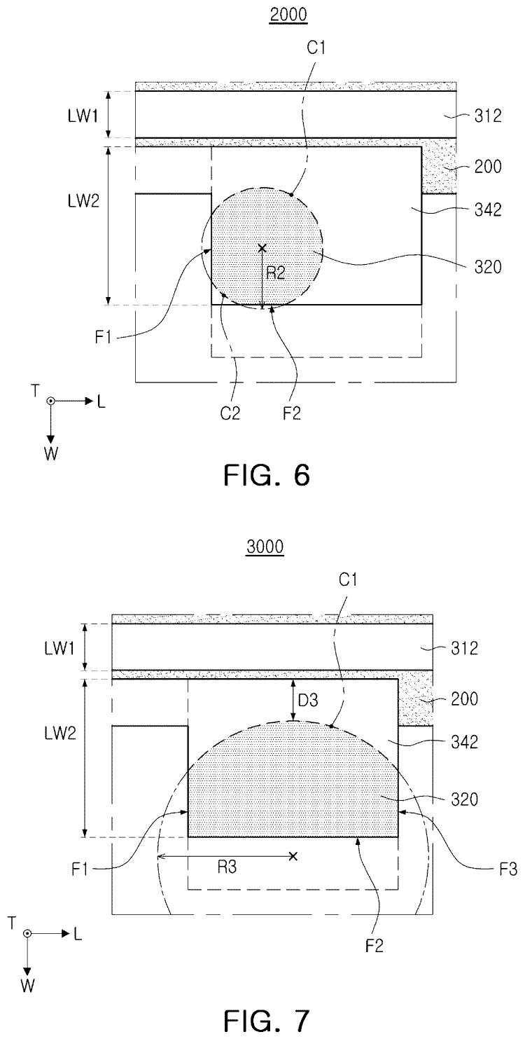

FIG. 6 is a diagram illustrating a via and a via pad of a coil component according to a second embodiment, corresponding to FIG. 3. FIG. 7 is a diagram illustrating a via and a via pad of a coil component according to a third embodiment, corresponding to FIG. 3.

Referring to FIGS. 6 to 7, as compared to the coil component 1000 according to the first embodiment, in coil components 2000 and 3000 according to the second and third embodiments, the line width of the via pads 341 and 342, the shape of the via 320, the number of exposed side surfaces F1 and F2 and the non-exposed side surface C1, C2, and C3, the center of curvature of the non-exposed side surface and the radius of curvature R2 and R3, a distance between the side surfaces of the via 320 and the side surfaces of the via pads 341 and 342 may be different.

Accordingly, in the description in the embodiment, only the vias 320 and via pads 341 and 342 different from the first embodiment of the present invention will be described. For the other configuration in the embodiment, the description in the first embodiment may be applied.

FIG. 6 is a diagram illustrating a via 320 and via pads 341 and 342 of a coil component 2000 according to a second embodiment, corresponding to FIG. 3.

Referring to FIG. 6, the via 320 in this embodiment may include first and second exposed side surfaces F1 and F2 not covered by the supporting member 200 and exposed among a plurality of side surfaces, and the first and the second exposed side surfaces F1 and F2 may be spaced apart from each other.

Also, the via 320 in the embodiment may include first and second non-exposed side surfaces C1 and C2 covered by the supporting member 200 and spaced apart from each other among the plurality of side surfaces, and the first or second non-exposed side surfaces C1 and C2 may connect the first and second exposed side surfaces to each other.

Also, in the via 320 in this embodiment, the center of curvature of the first or second non-exposed side surfaces C1 and C2 may be disposed in the internal side region of the via pads 341 and 342 with respect to the L-W cross-section, but an example embodiment thereof is not limited thereto.

The via pads 341 and 342 in the embodiment may have a larger line width LW2 than the example in the first embodiment, and the radius of curvature R2 of the via 320 may be smaller than the example in the first embodiment. Accordingly, the area of the removed region of the via 320 may be reduced, and among the side surfaces of the via 320, the second non-exposed side surface C2 covered by the supporting member 200 may be further included.

In the coil component 2000 according to the embodiment, the connection reliability and bonding strength between the via pads 341 and 342 and the via 320 may improve.

FIG. 7 is a diagram illustrating a via pads 341 and 342 and a via 320 of a coil component according to a third embodiment, corresponding to FIG. 3.

Referring to FIG. 7, the via 320 in the embodiment may further include a third exposed side surface F3 not covered by the supporting member 200 and exposed among the plurality of side surfaces, and the third exposed side surface F3 may be spaced apart from the first exposed side surface F1 and may be in contact with the second exposed side surface F2.

Also, the via 320 in the embodiment may be formed such that the non-exposed side surface C1 may connect the first and third exposed side surfaces F1 and F3 to each other.

Also, in the via 320 in the embodiment, the center of curvature of the non-exposed side surface C1 may be disposed in an external side region of the via pads 341 and 342 with respect to the L-W cross-section, but an example embodiment thereof is not limited thereto.

The via 320 in the embodiment may have a radius of curvature R3 larger than the example in the first or second embodiment. Accordingly, an area of a region in contact with the via 320 among the via pads 341 and 342 may increase, and the third exposed side surface F3 not covered by the supporting member 200 may be further included. Also, on the L-W cross-section, a distance D3 between the non-exposed side surface C1 of the via 320 and the side surfaces of the via pads 341 and 342 may be smaller than the example in the first or second embodiment.

Since it may be difficult reduce the diameter of the via hole 321h forming the via 320 in terms of process, even when the via pads 341 and 342 have a size relatively smaller than that of the via 320 as in the coil component 3000, connection reliability between the via pads 341 and 342 and the via 320 may be maintained through the above-described structure.

Process of Manufacturing Via Pad Using Barrier Rib

FIGS. 8A and 8B are diagrams illustrating a process of forming a coil portion using a barrier rib method in order.

Referring to FIG. 8A, a supporting member 200 may be prepared. The supporting member 200 may be a general copper clad laminate (CCL), and in this case, a thin copper foil 210 may be formed on both surfaces.

Thereafter the copper foil 210 may be removed from the supporting member 200 and a via hole 321h may be formed. The via hole 321h may be formed using a mechanical drill and/or a laser drill. In this case, the process of removing the copper foil 210 may not be performed and the copper foil 210 may be used as a seed, but an example embodiment thereof is not limited thereto. In this case, it may be necessary to create a seed layer 310 for the side surface of the via hole 321h.

Thereafter a seed layer 310 may be formed on both surfaces of the supporting member 200 and the wall surface of the via hole 321h. The seed layer 310 may be formed by a generally used method, such as, for example, chemical vapor deposition (CVD), physical vapor deposition (PVD), sputtering using a dry film, but an example embodiment thereof is not limited thereto.

Thereafter the barrier ribs 230 may be formed on both surfaces of the supporting member 200. Each of the barrier ribs 230 may be a resist film, and may be formed by a method of laminating and curing a resist film or a method of applying and curing a resist film material, but an example embodiment thereof is not limited thereto. As a lamination method, for example, a method of performing a hot pressing to cool to room temperature under reduced pressure after being pressurized at high temperature for a predetermined period of time, and separating a work tool by cooling in a cold press. As the coating method, for example, a screen printing method in which ink is applied with a squeeze, or a spray printing method in which ink is applied by misting may be used. The curing may be drying to not be completely cured so as to use a photolithography method as a post process.

The barrier rib 230 may have an opening 231h having a planar coil shape, and the opening 231h may be formed using a generally used photolithography method, that is, a generally used exposure and development method, and may be sequentially patterned or may be patterned at once. Exposure equipment or developer is not limited to any particular example, and may be appropriately selected and used depending on a photosensitive material to be used.

In this case, the barrier ribs 230 may be disposed to correspond to the shapes of the via pads 341 and 342, and the barrier ribs 230 may also be disposed in partial regions in the via hole 321h, such that the vias 320 may be formed along the shapes of the via pads 341 and 342 in the subsequent plating process.

Referring to FIG. 8B, first and second coil patterns 311 and 312, first and second via pads 341 and 342, vias 320, and first and second lead-out portions 331 and 332 may be formed using the opening 231h of the barrier rib 230 as a plating growth guide. In this case, since the components may be formed by a single plating process, the via 320 and the first and second via pads 341 and 342 may be integrated with each other.

In this case, the formed via 320 may be disposed in the via hole 321h and may connect the upper and lower first and second via pads 341 and 342 to each other, and may have the non-exposed side surface C1 and C2 covered by the supporting member 200, and exposed side surfaces F1, F2, and F3 not covered by the supporting member 200. That is, the via 320 may have the non-exposed side surfaces C1 and C2 in contact with the internal wall of the via hole 321h, and the exposed side surfaces F1, F2, and F3 not in contact with the internal wall of the via hole 321h.

As described above, as the via pads 341 and 342 and the via 320 are integrated with each other in the same process, the exposed side surfaces F1, F2, and F3 of the via 320 may be coplanar with one side surface of the supporting member 200, or one side surface of the via pads 341 and 342, but an example embodiment thereof is not limited thereto.

In the method of manufacturing the coil portion 300 using the barrier rib 230 as in the embodiment, an opening pattern may be formed in an insulator and plaiting may be performed using the opening pattern as a guide, Accordingly, differently from a general anisotropic plating technique, it may be easy to adjust the shape of the coil conductor. That is, the side surfaces of the first and second coil patterns 311 and 312 in contact with the barrier rib 230 may be flat. Here, the configuration in which the side surfaces are flat may indicate that the side surfaces may be completely flat, or may be substantially flat. That is, it is considered that the wall surface of the opening pattern may have roughness by the photolithography method. The plating method is not limited to any particular example, and electrolytic plating, or electroless plating may be used, but an example embodiment thereof is not limited thereto.

Thereafter after the first and second coil patterns 311 and 312, the first and second via pads 341 and 342, the via 320, and the first and second lead-out portions 331 and 332 are formed, the barrier rib 230 may be removed. The barrier rib 230 may be removed using a generally used stripper. In this case, after the barrier rib 230 is removed, the seed layer 310 may be etched to form a pattern.

Thereafter a through-hole 111h penetrating through the supporting member 200 may be formed through a trimming process. In this case, the supporting member 200 and the via 320 disposed between the first and second via pads 341 and 342 may also be trimmed together, and the side surfaces of the first and second via pads 341 and 342 in contact with the through-hole 111h, the via 320, and the supporting member 200 may correspond to each other and may be substantially coplanar, but an example embodiment thereof is not limited thereto.

The through-hole 111h may be formed using a mechanical drill and/or a laser drill. The through-hole 111h may be connected to the via hole 321h and may form a hole. During the trimming process, a penetrated region may be formed in the central part and also in the outer part. That is, in the trimming process, a penetrated region may be formed in the center and the outer portion may be formed such that the supporting member 200 may have a shape corresponding to the planar shape of the first and second coil patterns 311 and 312, and this region may be filled with a magnetic material, such that improved coil properties may be implemented.

Thereafter an insulating film IF may be formed to integrally cover the supporting member 200 and the coil portion 300. The insulating layer IF may be coated by chemical vapor deposition (CVD).

The body 100 may be formed by laminating magnetic sheets on the upper and lower portions of the manufactured supporting member 200 and the coil portion 300, and the first and second external electrodes 400 and 500 may be disposed on the surface of the formed body 100 so as to be connected to the coil portion 300 and to be spaced apart from each other.

According to the aforementioned example embodiments, since the area occupied by the via pad in the coil component may be reduced and the area of the core region may increase, a coil component having a reduced size and high capacitance properties may be implemented.

Also, even when the alignment between the via and the via pad is slightly misaligned or the size of the via and the via pad changes, connection reliability between the coil pattern and the via may be maintained.

While the example embodiments have been illustrated and described above, it will be apparent to those skilled in the art that modifications and variations could be made without departing from the scope of the present disclosure as defined by the appended claims.

What is claimed is:

1. A coil component, comprising:
a body;
a supporting member disposed within the body;
a coil portion including a coil pattern disposed on at least one surface of the supporting member, a via pad connected to the coil pattern, and a via connected to the via pad; and
an external electrode disposed on the body and connected to the coil portion,
wherein the via includes a plurality of side surfaces, one or more of the side surfaces is covered by the supporting member, and at least a portion of two or more of the side surfaces is non-covered by the supporting member.

2. The coil component of claim 1,
wherein, among the plurality of side surfaces, the two or more side surfaces not covered by the supporting member include first and second side surfaces, and
wherein the first and second side surfaces meet to share a corner.

3. The coil component of claim 2, wherein the first and second side surfaces meet vertically.

4. The coil component of claim 2, wherein each of the first and second side surfaces are planar.

5. The coil component of claim 2, wherein each of the first and second side surfaces are cut-surfaces.

6. The coil component of claim 1, wherein one of the two or more of the side surfaces, non-covered by the supporting member, among the plurality of side surfaces, is coplanar with one side surface of the supporting member.

7. The coil component of claim 6, wherein the one of the two or more of the side surfaces, non-covered by the supporting member, among the plurality of side surfaces, is coplanar with one side surface of the via pad.

8. The coil component of claim 1,
wherein, among the plurality of side surfaces, the two or more side surfaces non-covered by the supporting member include first and second side surfaces, and
wherein the first and second side surfaces are spaced apart from each other.

9. The coil component of claim 2, wherein a side surface covered by the supporting member among the plurality of side surfaces is a curved surface.

10. The coil component of claim 9,
wherein the side surface covered by the supporting member among the plurality of side surfaces includes third and fourth side surfaces spaced apart from each other, and
wherein the third or fourth side surface connecting the first and second side surface to each other.

11. The coil component of claim 10, wherein a center of curvature of the third or fourth side surface is disposed in an internal side region of the via pad.

12. The coil component of claim 9,
wherein, among the plurality of side surfaces, the two or more side surfaces non-covered by the supporting member further include a fifth side surface, and
wherein the fifth side surface is spaced apart from the first side surface, and is in contact with the second side surface.

13. The coil component of claim 12, wherein the side surface covered by the supporting member among the plurality of side surfaces connects the first and fifth side surfaces to each other.

14. The coil component of claim 12, wherein a center of curvature of the side surface covered by the supporting member among the plurality of side surfaces is disposed in an external side region of the via pad.

15. The coil component of claim 1,
wherein the body includes a core penetrating the supporting member, and
wherein the coil pattern has a spiral shape including at least one turn around the core.

16. The coil component of claim 15, wherein the via pad extends from the coil pattern and protrudes toward the core.

17. The coil component of claim 1, wherein a line width of the via pad is greater than a line width of the coil pattern.

18. The coil component of claim 2, further comprising:
an insulating film integrally covering the coil portion and the supporting member.

19. The coil component of claim 18, wherein the first and second side surfaces are in contact with the insulating film.

20. The coil component of claim 1, wherein the via pad and the via are integrated with each other.

21. The coil component of claim 1, wherein a distance, in a width direction of the body, between a curved surface of the via and one side surface of the via pad is different from a distance, in a length direction of the body, between the curved surface of the via and another side surface of the via pad.

22. A coil component, comprising:
a body;
a supporting member disposed within the body;
a coil portion including a coil pattern disposed on at least one surface of the supporting member, a via pad connected to the coil pattern, and a via connected to the via pad; and
an external electrode disposed on the body and connected to the coil portion,
wherein among the via pad and the supporting member, only the supporting member includes a via hole in which the via is disposed, and
the via includes at least one side surface non-covered by the supporting member.

23. The coil component of claim 22, wherein the at least one side surface, non-covered by the supporting member, among the plurality of side surfaces, is coplanar with one side surface of the supporting member.

24. The coil component of claim 22, wherein the at least one side surface, non-covered by the supporting member, among the plurality of side surfaces, is coplanar with one side surface of the via pad.

25. The coil component of claim 22, wherein a side surface covered by the supporting member among the plurality of side surfaces includes a curved surface.

26. The coil component of claim 22, wherein a center of curvature of the side surface covered by the supporting member among the plurality of side surfaces is disposed in an external side region of the via pad.

27. The coil component of claim 22, further comprising an insulating film covering the coil portion and the supporting member,
wherein the first and second side surfaces are in contact with the insulating film.
